(19) United States
(12) Patent Application Publication
(10) Pub. No.: US 2007/0045258 A1
(43) Pub. Date: Mar. 1, 2007

(54) NOZZLE POLISHING DEVICE IN LASER PROCESSING MACHINE

(76) Inventors: Tsunehiko Yamazaki, Aichi pref (JP); Naoomi Miyakawa, Aichi pref (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/420,278

(22) Filed: May 25, 2006

(30) Foreign Application Priority Data
Aug. 30, 2005 (JP) 2005-249695

(51) Int. Cl. B23K 26/14

(52) U.S. Cl. 219/121.84

(57) ABSTRACT

A device is provided to remove sputtered materials adhering to a nozzle in a laser processing machine. In a laser processing, some sputtered material S₁ adhering to a nozzle 65 degrades copy operations in the processing. A nozzle polishing device 600 comprises a processing head 610, and drives a processing tool 620 which may be a formed grindstone. The processing tool 620 of the formed grindstone has a processing surface 622 which is brought into contact with the nozzle 65 to remove the sputtered material S₁.

The present application is based on and claims priority of Japanese patent application No. 2005-249695 filed on Aug. 30, 2005, the entire contents of which are hereby incorporated by reference.

### BACKGROUND OF THE INVENTION

1. Field of the Invention

The present invention provides means for unattended operation for a long time of period by removing contaminants with a cutting tool such as a grinding tool when contaminants adhere to a nozzle of a laser processing machine.

2. Description of the Related Art

In a conventional laser processing machine, predetermined standard processing conditions defined by materials and thicknesses are registered in a numeral count device (NC device). During a laser processing according to the processing conditions, any trouble in the function of a nozzle mounted to the tip of a processing torch causes imperfections in the processing such as dross forming. In order to maintain the optimal processing conditions, an operator needs to detect such a trouble of a nozzle in ahead, stop a machine, and examine the nozzle for abnormality, and when a trouble is recognized, the nozzle should be manually changed or be cleaned, any deformation of the nozzle should be adjusted, or the processing conditions should be changed. Japanese Patent Laid-Open Publication No. 2001-150173 Publication (Patent Document 1) discloses a machine having a brush for removing dross which adheres to a nozzle.

During a laser processing, some melt (sputtered material) in the processing flies above a work surface, due to the pressure of an assist gas for example, and adheres to a bottom surface of a nozzle, which makes a gap between the bottom surface of the nozzle and the upper work surface non-uniform. The patent document above described discloses a copy operation to control the position of a laser processing tool in the Z axis direction which records a Z axis coordinate by bring a nozzle into contact with a touch sensor. The patent document also discloses a method for removing contaminants such as dross adhering to a nozzle by bringing a nozzle tip to a brush so that a circular motion of the nozzle removes the contaminants. The present invention provides a device having a polishing device to polish a nozzle without moving the nozzle.

### SUMMARY OF THE INVENTION

A laser processing machine according to the present invention comprises: a bed; a pellet disposed on the bed to support a work; a column which is controlled to move along the X axis, the X axis being the longitudinal axis of the bed; a saddle which is supported by the column and is controlled to move along the Y axis, the Y axis being perpendicularly crossing the X axis; a processing head which is supported by the saddle and is controlled to move along the Z axis, the Z axis being perpendicular to a plane defined by the X axis and the Y axis. The present invention provides a nozzle polishing device comprising a melt removing device for removing melt with a grinding tool, the melt adhering to a tip nozzle of a laser processing tool mounted to the processing head as basic means.

According to the present invention, because a copy function is stabilized so that a gap between a bottom surface of a nozzle and an upper work surface becomes uniform, imperfections in a processing such as dross forming are not caused, which stabilizes the processing and makes an unattended operation for a long time of period possible.

### BRIEF DESCRIPTION OF THE DRAWINGS

FIG. 1 is a perspective view to generally show a laser processing machine according to the present invention;

FIG. 2 is a plan view to show a laser processing machine according to the present invention;

FIG. 3 is an elevational view to show the main parts of a laser processing machine according to the present invention;

FIG. 4 is a perspective view to show the main parts of a laser processing machine according to the present invention;

FIG. 5 is a side view to show the main parts of a laser processing machine according to the present invention;

FIG. 6 is an elevational view to show a setup station for a laser processing tool;

FIG. 7 is a plan view to show a setup station for a laser processing tool;

FIG. 8 is a view to illustrate a nozzle polishing device;

FIG. 9 is a view to illustrate a nozzle polishing device;

FIG. 10 is a view to illustrate another example of a nozzle polishing device; and

FIG. 11 is a view to illustrate another example of a nozzle polishing device.

### DETAILED DESCRIPTION OF THE PREFERRED EMBODIMENTS

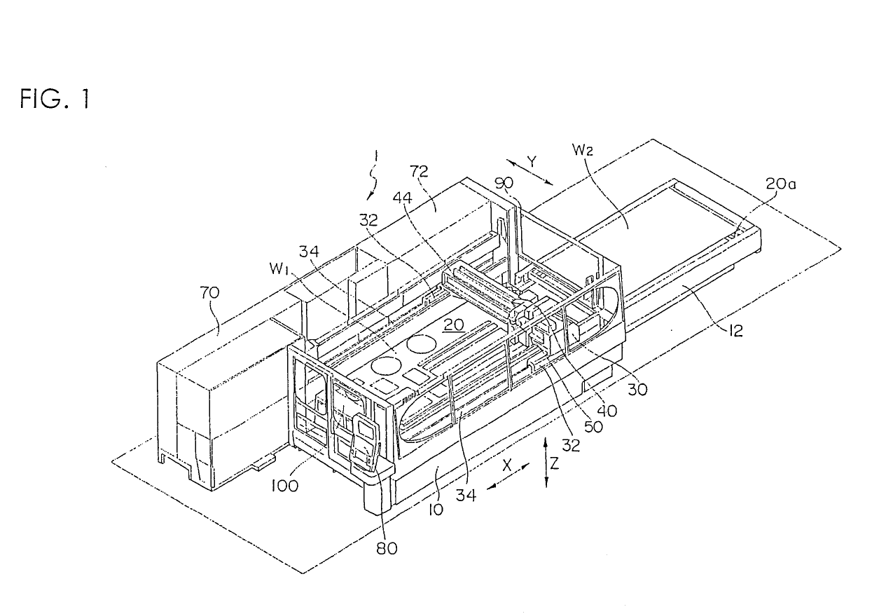

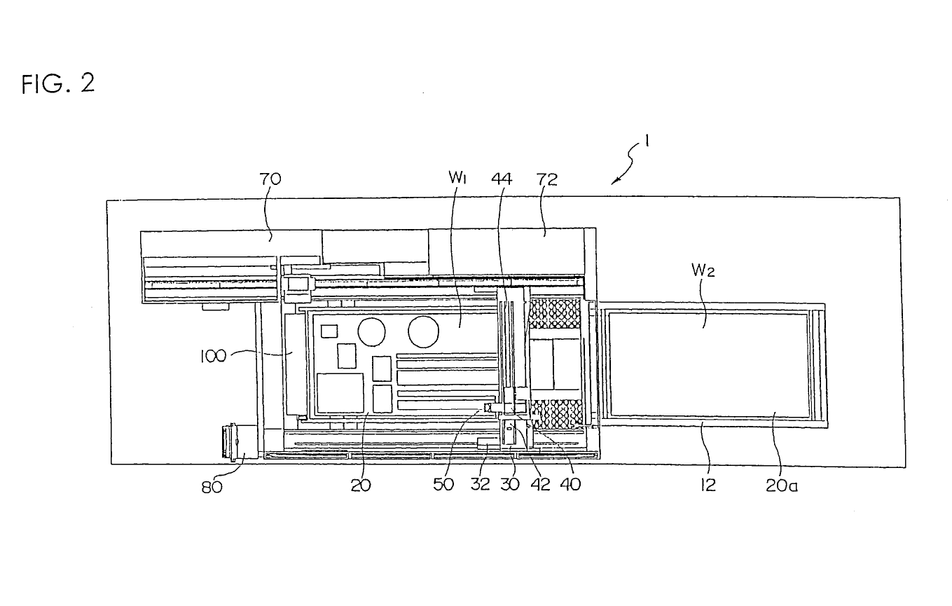

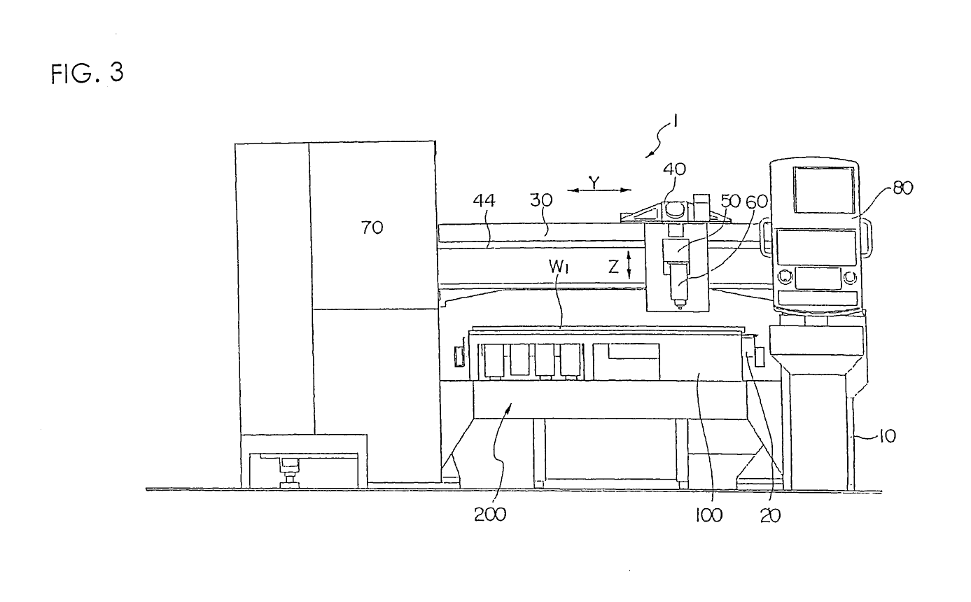

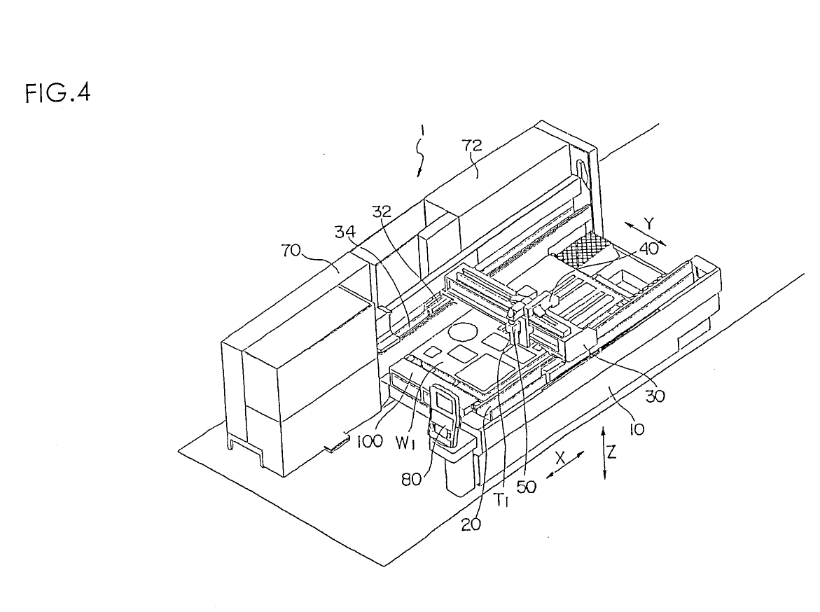

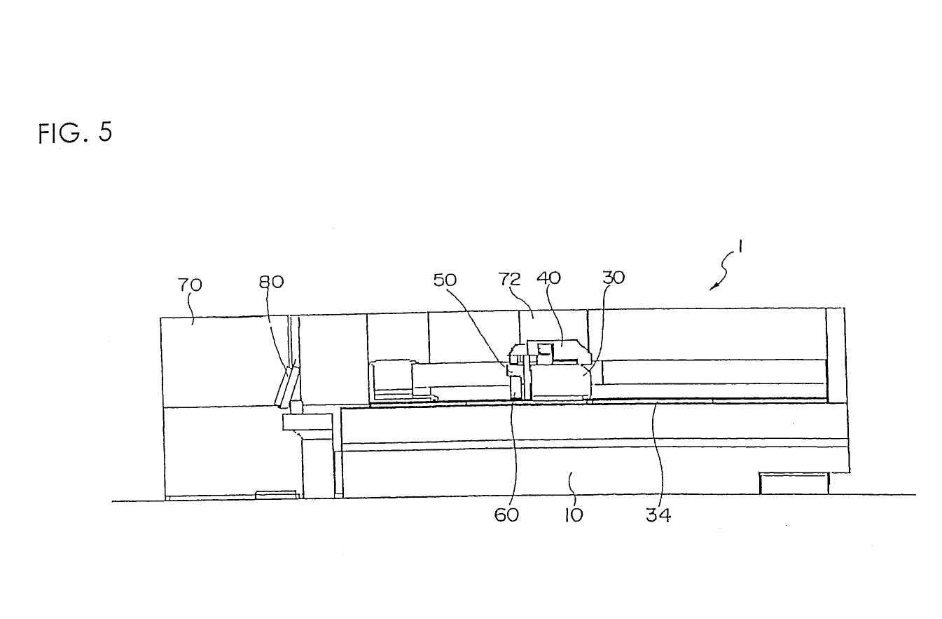

FIG. 1 is a perspective view to generally show a laser processing machine according to the present invention. FIG. 2 is a plan view of the same, FIG. 3 is an elevational view of the same, FIG. 4 is a perspective view to show the main parts of the same, and FIG. 5 is a side view to show the main parts of the same. A laser processing machine, which is generally denoted by reference numeral 1, has a bed 10 and a pallet (table) 20 disposed on the bed 10, and a sheet of a work W₁ is rested on the pellet 20. A pallet exchanging device 12 is arranged adjacent to the bed 10 in the longitudinal direction of the bed 10, having a pallet 20a on which a work W₂ is rested for a subsequent processing.

A pair of guide rails 34 are provided along both of the longitudinal sides of the bed 10, and a column 30 is mounted on the guide rails 34 to be movable in the X axis direction.

The column 30 may move in the X axis direction driven by for example a linear motor which is formed with a stator provided to the guide rails 34 and movers provided to translation guides 32.

The column 30 includes a guide rail 44 provided along the Y axis which is perpendicularly crossing the X axis to mount a saddle 40 movable in the Y axis direction. The saddle 40 includes a translation guide 42 which engages with the guide rail 44, which forms a linear motor between the guide rail 44 and the translation guide 42.

The saddle 40 includes a guide rail in the Z axis direction which is perpendicular to a plane defined by the X axis and the Y axis, and a processing head 50 is mounted to the guide rail movable along the Z axis. The processing head 50 includes an optical system into which a laser beam is introduced from a laser emitting device 72.

To the processing head 50, a laser processing tool 60 is exchangeably mounted. A processing area is covered with a cover 90 for safety. An electric cabinet 70 and the laser emitting device 72 are arranged adjacent to the bed 10. A control panel 80 through which an operator issues commands for various operations is disposed at one end of a longitudinal side of the bed 10. At one end of the bed 10 which is close to the control panel 80, a setup station 100 for a laser processing tool is equipped with.

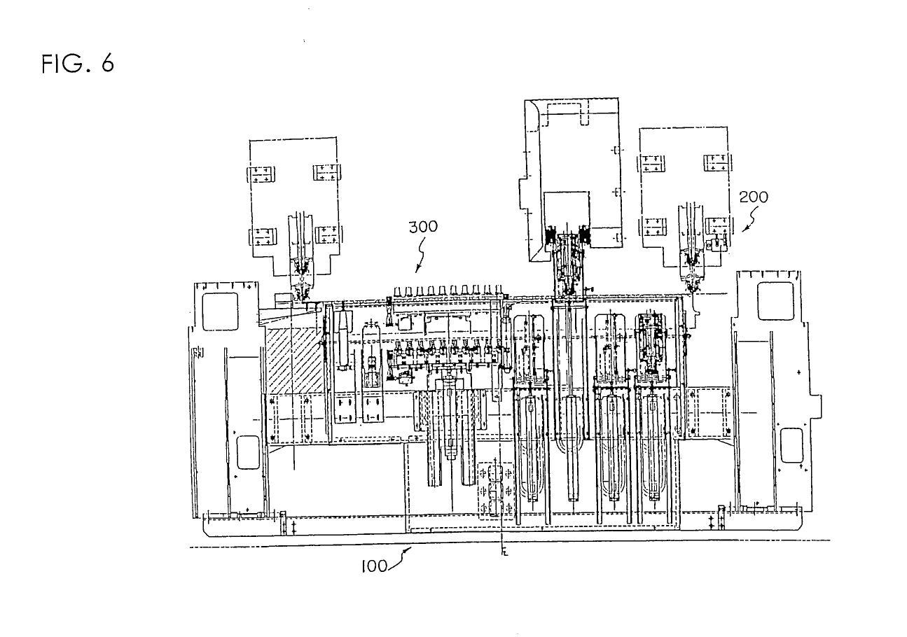

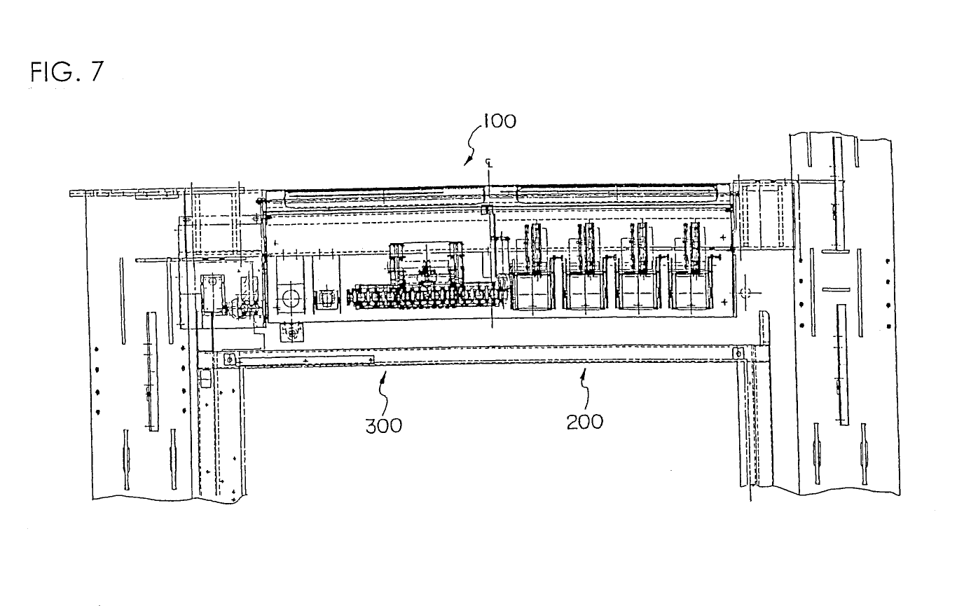

FIG. 6 is an elevational view to show the setup station 100 for a laser processing tool as seen from the table, and FIG. 7 is a plan view to show the same. The setup station 100 for a laser processing tool includes: a tool station 200 equipped with a tool change magazine for laser processing tools having a torch and a nozzle respectively; and a nozzle station 300 equipped with a nozzle change magazine for nozzles of the laser processing tools.

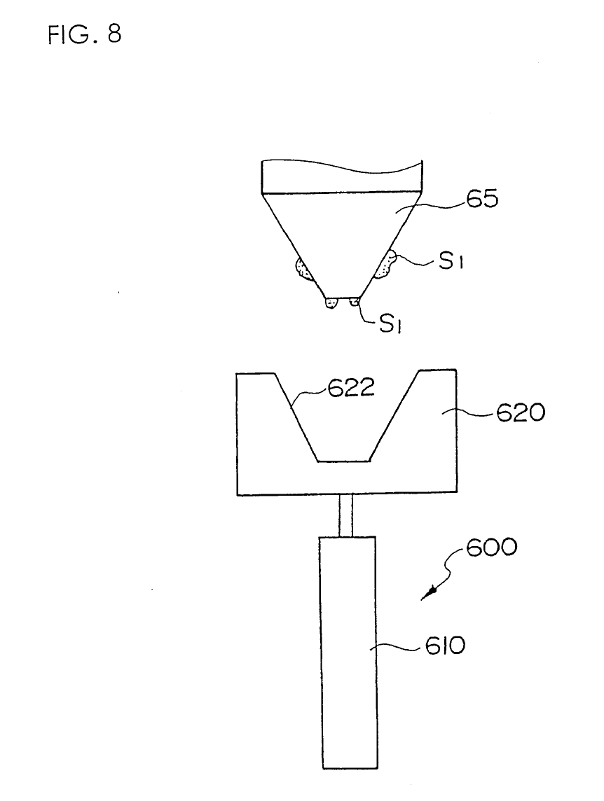

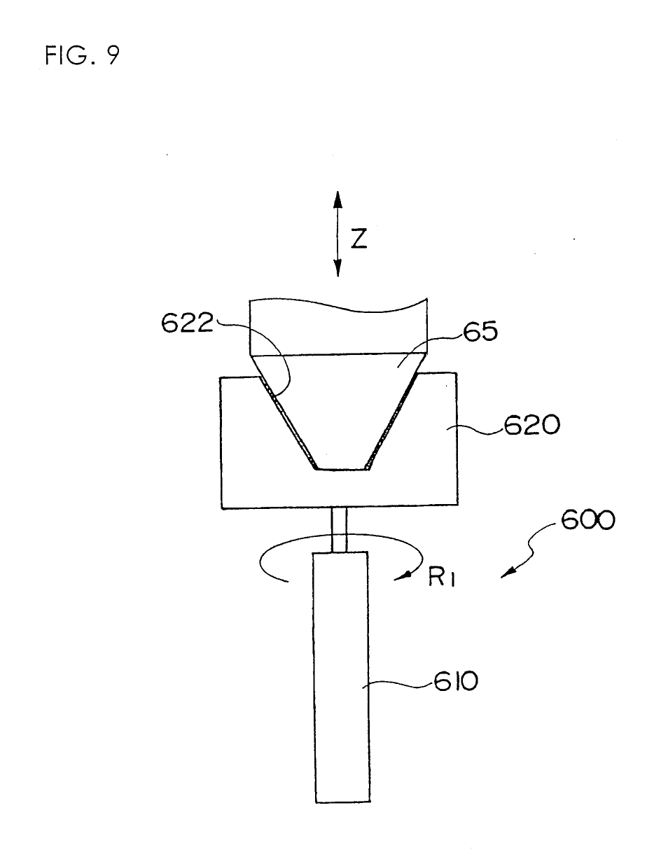

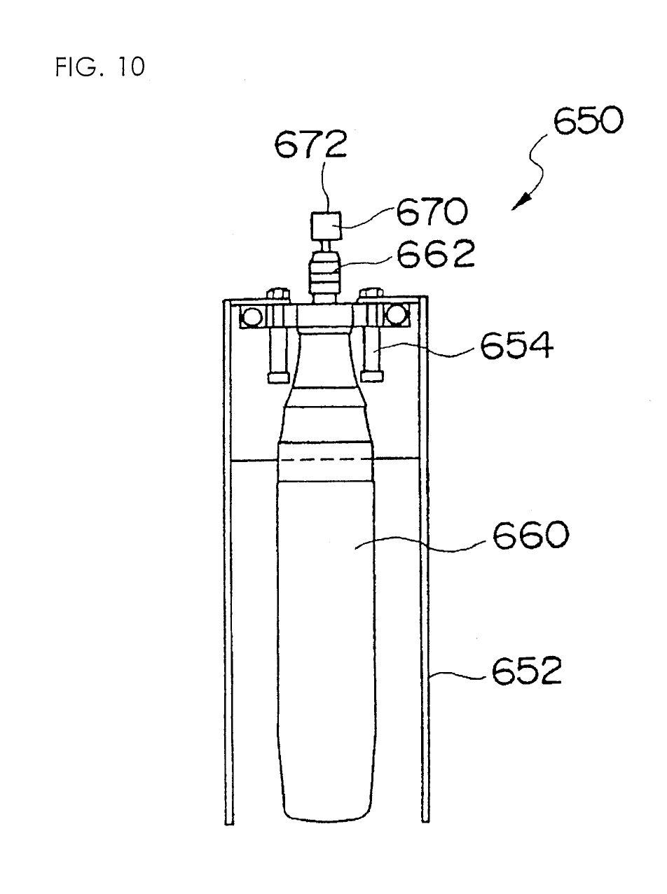

FIG. 8 is a view to illustrate a nozzle polishing device according to the present invention. A nozzle polishing device 600 includes a processing head 610, and the processing head 610 drives a processing tool 620 which is a formed grindstone. The processing tool 620 may be a formed grindstone having a processing surface 622 corresponding to the outer configuration of a nozzle 65. As shown in FIG. 9, a laser processing head equipped with the nozzle 65 to which sputtered material S₁ adheres is positioned above the nozzle polishing device 600, and the entire laser processing tool is lowered in the Z axis direction. Then, the processing tool 620 of the nozzle polishing device 600 is rotated and the nozzle 65 is brought into contact with the processing surface 622, thereby the sputtered material adhering to the nozzle 65 is ground and removed. FIG. 10 is a view to illustrate another example of a nozzle polishing device. A nozzle polishing device 650 has a frame 652 and a processing head 660 which is supported with bolts 654 in the frame 652. The processing head 660 is equipped with a motor therein, and has a rotation shaft 662 mounted with a cylindrical grindstone 670. The cylindrical grindstone 670 has an upper surface 672 which is used to polish and remove contaminants such as dross adhering to a bottom end surface of the nozzle 65.

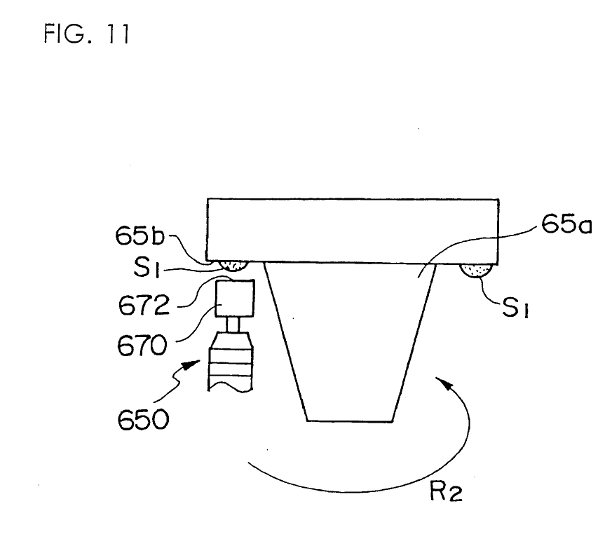

FIG. 11 is a view to illustrate another example of a nozzle polishing device according to the present invention. A nozzle 65a includes a flange portion 65b, and sputtered material S₁ adhering to the flange portion 65b sometimes causes imperfections in a processing. Thus, a nozzle polishing device 650 is used so that an upper surface 672 of a cylindrical grindstone 670 is brought into contact with the flange portions 65b of the nozzle 65a to remove the sputtered material S₁. The nozzle polishing device 650 is moved in circle along the flange portions 65b in the direction shown by an arrow R₂ to complete the removal of the sputtered material S₁.

In the above examples, a grindstone is used as a polishing tool for a nozzle, but of course, other tools such as a carbide tool may be used as needed.

What is claimed is:

1. In a laser processing machine comprising: a bed; a pellet disposed on the bed to support a work; a column which is controlled to move along the X axis, the X axis being the longitudinal axis of the bed; a saddle which is supported by the column and is controlled to move along the Y axis, the Y axis being perpendicularly crossing the X axis; and a processing head which is supported by the saddle and is controlled to move along the Z axis, the Z axis being perpendicular to a plane defined by the X axis and the Y axis,
a nozzle polishing device comprising a melt removing device for removing melt with a grinding tool, the melt adhering to a tip nozzle of a laser processing tool mounted to the processing head.

2. The nozzle polishing device in a laser processing machine according to claim 1, wherein the laser processing tool comprises a torch having an optical system including a condenser lens, and a nozzle which is exchangeably mounted to the tip of the torch.

3. The nozzle polishing device in a laser processing machine according to claim 1, wherein further comprising a formed grindstone which is mounted to the melt removing device.

4. The nozzle polishing device in a laser processing machine according to claim 1, wherein further comprising a plurality of melt removing devices each of which are equipped with a polishing tool corresponding to a type of a nozzle.
